(19) United States
(12) Patent Application Publication
(10) Pub. No.: US 2020/0154743 A1
(43) Pub. Date: May 21, 2020

(54) PACKAGED FOOD PRODUCT COMPRISING A SHEET OF DOUGH

(71) Applicant: INDUSTRIE ROLLI ALIMENTARI S.P.A., Roseto Degli Abruzzi (IT)

(72) Inventor: Gian Paolo ROLLI, Franzione S. Michele di Torre (IT)

(21) Appl. No.: 16/604,016

(22) PCT Filed: Apr. 12, 2017
(86) PCT No.: PCT/IT2017/000073

§ 371 Date: Oct. 9, 2019

(51) Int. Cl. A23L 7/109; A21D 15/02; A21D 10/02; A21C 3/02; A21C 3/04; A21C 9/06; B65B 25/00; B65B 57/00

(52) U.S. Cl. CPC A23L 7/111; A21D 15/02; A21D 10/025; A21C 3/022; A23V 2002/00; A23L 7/11; A21C 9/063; B65B 25/001; B65B 57/005; A21C 3/04

(57) ABSTRACT

A packaged food product has a sheet of dough, and the sheet of dough includes at least two elements chosen preferably from water, legume flour, rice flour, vegetables, vegetable fibers and starches. The packaged food product having the sheet of dough is frozen and further includes a container. A method for preparing a sheet of dough includes at least the steps of receiving, storing and transferring raw materials required to prepare the sheet of dough; mixing and amalgamating the raw materials until a uniform mixture is obtained; and passing the mixture through a machine in order to obtain a uniform sheet of dough. The dough is then cooked, cooled, and cut, then frozen and packaged.

### TECHNICAL FIELD

The present disclosure relates to a packaged food product of the type comprising a sheet of dough, a packaged pasta, provided by means of said sheet of dough, and to the associated methods.

### BACKGROUND

The innovation lies within the field of the ongoing evolution of the social and cultural context, which is characterized by a growing attention of the populations of advanced countries to healthy and balanced nutrition: increasingly numerous information campaigns in fact highlight its importance, identifying it as a key element for preserving the psychological and physical well-being of the individual.

This trend is leading to the large-scale success of products, such as for example gluten-free products, which used to be considered niche products intended only for specific categories of people with food intolerance problems.

Furthermore, new lifestyles and consumption styles are leading consumers to privilege new categories of health-related food products with high added value.

In these products, the differentiating content is clearly referenced on the package: consider, for example, products with high added value which bear claims such as “source of protein”, “saturated fat free”, “with high fiber content”, as prescribed by the national and continental standards (for example, Rule EC 1924/2006 related to nutritional and health-related indications provided on food products).

An example of this is a category of products that have been introduced recently on the market, such as dry vegetable pastas which allow to maintain a high protein input from non-animal sources and can bear wording related to the nutritional content “source of protein”, “source of fiber”, and the like, in addition to qualifying themselves, depending on the instance, as “gluten-free”, “vegan product”, “vegetarian product”.

In terms of the offer of vegetable pastas, currently there are many commercially available dry pastas (macaroni, spaghetti and the like), obtained only with flour of legumes (lentils, peas, chickpeas and the like) and of rice, to be used as an alternative to traditional pastas made from wheat semolina.

Next to these types of pasta there are dry dough sheet pastas for lasagna, again based on flour of legumes, rice and the like, which can be used freely to prepare, at home or in cuisine, complete dishes.

The use and consumption of this type of vegetable food products, however, are not yet widespread, in particular because convincing and practical commercial solutions which allow the consumer to include them in his/her daily diet without having to prepare them autonomously are not yet commercially available.

### SUMMARY

The aim of the present disclosure is to offer a commercial response to the new emerging needs mentioned above by proposing a packaged food product of the type comprising a sheet of dough and a packaged pasta, provided by means of said sheet of dough, which are quick and easy to prepare for immediate consumption and with a useful shelf life of up to 18 months.

Within this aim, the disclosure proposes a packaged food product of the type comprising a sheet of dough and a packaged pasta, provided by means of said sheet of dough, that is gluten free.

The present disclosure further provides a packaged food product of the type comprising a sheet of dough and a packaged pasta, provided by means of said sheet of dough, that contains a high percentage of substances rich in non-animal proteins.

The present disclosure also proposes a packaged food product of the type comprising a sheet of dough and a packaged pasta, provided by means of said sheet of dough, that does not contain eggs.

The present disclosure further provides a packaged food product of the type comprising a sheet of dough and a packaged pasta, provided by means of said sheet of dough, that is suitable to be consumed by people following a vegetarian diet.

The present disclosure also proposes a packaged food product of the type comprising a sheet of dough and a packaged pasta, provided by means of said sheet of dough, that does not contain additives such as flavor enhancers, preservatives, colors, aromas, and thus can carry a so-called clean label.

The present disclosure provides a packaged food product of the type comprising a sheet of dough and a packaged pasta, provided by means of said sheet of dough, that has modest costs, is relatively simple to provide in practice and is safe in application.

This aim and these advantages, as well as others which will become better apparent hereinafter, are achieved by providing a packaged food product of the type comprising a sheet of dough, characterized in that said sheet of dough comprises at least two elements chosen preferably from:
water;
legume flour;
rice flour;
vegetables;
vegetable fibers;
starches;

in that said product comprises a container and in that said product is frozen.

This aim and these advantages are also achieved by providing a packaged pasta that it is frozen and comprises:
a container; and
a pasta format constituted by a sheet of dough which contains at least two elements chosen preferably from water, legume flour, rice flour, vegetables, vegetable fibers and starches.

Furthermore, this aim and these advantages are achieved by providing a method for preparing a sheet of dough, the method including the following steps:
receiving, storing and transferring the raw materials required for the preparation of said sheet of dough, said raw materials comprising at least two elements chosen preferably from water, legume flour, rice flour, vegetables, vegetable fibers and starches;
mixing and amalgamating said raw materials until a uniform mixture is obtained;
passing the mixture through a machine preferably chosen from an extruder, a laminator and the like, in order to obtain a uniform sheet of dough;
cooking said sheet of dough;
cooling said sheet of dough;
cutting said sheet of dough according to a predefined shape and dimensions, by using a cutting device;
freezing said dough sheet cuttings by means of a freezer;
packaging said dough sheet cuttings in a container; and
checking, by using a device of the type of a metal detector, X-ray detectors, and the like, for any presence of foreign objects inside said containers.

This aim and these advantages are also achieved by providing a method for preparing pasta, the method including the steps of
receiving, storing and transferring the raw materials required for the preparation of said sheet of dough, said raw materials comprising at least two elements preferably chosen from water, legume flour, rice flour, vegetables, vegetable fibers and starches;
mixing and amalgamating said raw materials until a uniform mixture is obtained;
passing the mixture through a machine chosen preferably from an extruder, a laminator and the like, in order to obtain a uniform sheet of dough;
performing, in any sequence, at least one step of mechanical treatment, a cooking step, a cooling step and at least one step for cutting the sheet of dough, in order to obtain a predefined pasta format; and
performing, in any sequence, at least one step for freezing said pasta and at least one step for packaging it inside a container.

### DETAILED DESCRIPTION OF THE DISCLOSURE

Further characteristics and advantages of the disclosure will become better apparent from the description of a preferred but not exclusive embodiment of the packaged food product, of the type comprising a sheet of dough, a packaged pasta, provided with said sheet of dough, and associated methods.

The sheet of dough according to the disclosure comprises at least two elements chosen preferably from water, legume flour, rice flour, vegetables, vegetable fibers and starches.

The possibility is not excluded that in a particular embodiment the sheet of dough, the optional filling and/or any seasoning might also comprise egg or egg parts.

Water can be present in the sheet of dough in a maximum percentage value of 60%.

It is specified that the legume flour and rice flour can be present in a maximum percentage value of 90%.

Furthermore, the vegetables can be present in a maximum percentage value of 50%.

These vegetables can be frozen or obtained by means of a process for sterilization and packaging in a protected environment in order to avoid bacterial contamination.

It is further appropriate to specify that it is possible to use, in a percentage value up to 60%, vegetables also in order to give a predefined color to the pasta in a natural manner.

Furthermore, it is specified that the vegetable fibers and starches can be present in a percentage value comprised up to 25%.

According to the disclosure, the packaged food product of the type comprising said sheet of dough is frozen and comprises a container.

The present disclosure is also aimed at protecting a packaged pasta.

Said pasta, according to the disclosure, is frozen and comprises a container and a pasta format constituted by a sheet of dough which contains water, legume flour, rice flour, vegetables, vegetable fibers and starches.

The possibility is not excluded that in a particular embodiment the sheet of dough, the optional filling and/or the optional seasoning may also comprise egg or egg parts.

Water can be present within the sheet of dough in a maximum percentage value of 60%.

It is specified that the legume flour and rice flour can be present in a maximum percentage value of 90%.

Furthermore, the vegetables can be present in a maximum percentage value of 50%.

These vegetables can be frozen or obtained by means of a process for sterilization and packaging in a protected environment in order to avoid bacterial contamination.

Furthermore, it is appropriate to specify that it is possible to use, in a percentage value up to 60%, vegetables to give a predefined color to the pasta in a natural manner.

It is specified further that the vegetable fibers and starches can be present in a percentage value comprised up to 25%.

It is specified that the pasta according to the disclosure may comprise a seasoning in order to season the pasta itself.

Said seasoning can be a sauce and the like, used to give the pasta specific organoleptic characteristics, providing the consumer with a complete dish.

More particularly, the pasta format can be of the type chosen preferably from a lasagna, a cannelloni, a pasta with filling, a tagliatella, a crespella and the like.

Furthermore, it is appropriate to specify that the vegetables contained within the sheet of dough (or in the seasoning) can be of the type preferably chosen from beet, garlic, asparagus, basil, white beet, broccoli, artichokes, carrots, cauliflowers, chicory, rapini, onion, chickpeas, string beans, borlotti beans, green beans, broad beans, fennels, lentils, aubergines, peppers, potatoes, peas, tomatoes, leeks, parsley, celery, escarole, spinach, cabbage, pumpkins, zucchini and the like.

Furthermore, it is specified that the vegetables used can comprise a pesticide residue lower than a predefined threshold.

Said predefined threshold can be 0.01 mg/kg.

In any case, the possibility is not excluded that the vegetables used may be of the type that originates from organic farming.

It is specified that the sheet of dough and the packaged pasta provided with said sheet of dough according to the disclosure, being provided with products that originate from organic farming, also are products of the organic type.

According to a particularly useful and practical solution, the container can be constituted by a boxlike body, a pouch, a combination thereof, and the like.

According to a different solution that is particularly effective and efficient, the container can be at least partially constituted by at least one material selected among ethylene vinyl alcohols (EVOH), polyamide (PA), polyethylene (PE), polyethylene terephthalate (PET), lignin, Cartene, corn-derived polymers, (vegetable) cellulose, paper, cardboard, in order to render the recyclable container of a type that is preferably chosen from microwave resistant, partially recyclable and compostable.

In particular, if the container is at least partially constituted by at least one material selected from ethylene vinyl alcohols (EVOH), polyamide (PA), polyethylene (PE), lignin, Cartene, corn-derived polymers, (vegetable) cellulose, paper, cardboard, it is of a microwave-resistant type.

It is therefore possible for the consumer to perform cooking in a flying pan or by means of a traditional oven directly in the container or microwave oven of said pasta.

If cooking by means of a microwave oven is used, it is specified that said container, being microwave resistant, can also be used as a cooking vessel and optionally as a dish within which to eat the pasta contained therein after microwave cooking, simplifying and optimizing the entire process for use of the pasta.

Furthermore, if the container is at least partially constituted by at least one material selected from ethylene vinyl alcohols (EVOH), polyamide (PA), polyethylene (PE), it is of a type that is recyclable for a percentage comprised between 96% and 98%.

The possibility is not excluded that the container might be constituted by a box-like cardboard body provided with an internal lining layer made of a material of the type of ethylene vinyl alcohol (EVOH), polyamide (PA), polyethylene (PE) and polyethylene terephthalate (PET).

More particularly, the grammage of the cardboard can be preferably 300 g/m², while the grammage of the lining layer can be preferably 20 g/m².

It is not excluded, however, that the grammage of the boxlike body and of the lining might be different.

Furthermore, the possibility is not excluded that the container might be a tray provided with a closure film made of polymeric material.

Once the food has been eaten, it is therefore possible to separate the container from the closure film for their separate recycling.

Different formats are further provided depending on the number of portions provided.

The nutritional information of the pasta can be applied directly to the container or on a band that wraps around the container, if the container is shaped like a boxlike body, for example a tray.

In order to clarify which are the packaged pastas according to the disclosure, some examples of the types of pasta that can be provided are given hereinafter.

It is specified that these examples merely have an illustrative intent and therefore cannot be considered suitable for a limitation of the protective scope of the present disclosure.

### Example 1: Green Lentil Flour Lasagna with Cheese

The packaged pasta comprises a container inside which there are, arranged in layers, 23% precooked dough sheet cuttings (made with 47.9% green lentil flour, 47.1% water, 5% corn starch and vegetable fibers) seasoned with a sauce with 70.5% cheese (constituted by 55.3% water, 11.6% cream, 10.5% Emmenthal®, 7.4% powdered skimmed milk, 6.3% sunflower seeds, 4.2% modified rice starch, 3.2% butter, 0.9% frozen onion, 0.5% salt, 0.09% powdered nutmeg, 0.01% powdered white pepper) and having on the bottom 5.1% sunflower seed oil and an upper finishing layer which contains 46.2% dried tomatoes, 20.5% chevre cheese, 20.5% gluten-free grated bread, 7.7% parsley.

### Example 2: Green Lentil Flour and Chickpea Flour Lasagna with Ricotta and Pumpkin Sauce

The packaged pasta comprises a container inside which there are 19.7% precooked pasta rectangles (provided by means of 52.1% water, 37.2% green lentil flour, 5% chickpea flour, 4.5% corn starch and vegetable fibers, 1.2% powdered beetroot), arranged in layers, seasoned with 5.7% frozen diced grilled pumpkin, 5.7% grated cheese, 1.1% pumpkin seeds, a 25.8% pumpkin sauce (constituted by 40.6% water, 30.6% frozen pumpkin purée, 10.2% frozen onion, 10.2% cream, 3.1% sunflower seed oil, 2.6% modified corn starch, 1.2% salt, 1% parsley, 0.3% garlic, 0.1% black pepper, 0.1% rosemary, 0.1% sage) and a 42% ricotta sauce (constituted by 51.4% water, 20.8% ricotta, 10.4% cream, 5.2% sunflower seed oil, 4.2% cheese, 4.2% powdered skimmed milk, 3.1% modified corn starch, 0.6% salt, 0.1% powdered nutmeg).

### Example 3: Green Lentil Flour Ravioli with Tomato Sauce

The packaged pasta comprises a container inside which there are 37.6% filled precooked ravioli constituted by 28.2% green lentil flour, 23.3% water, 3% corn starch and vegetable fibers, 27.4% ricotta, 6.8% frozen spinach, 5% mascarpone, 3.8% cheese, 1.4% frozen grilled onion, 0.5% frozen onion, 0.2% salt, 0.2% modified rice starch, 0.1% garlic, 0.1% powdered nutmeg, seasoned with 3% mozzarella, 0.3% basil and 59.1% tomato sauce (constituted by 81.1% tomato pulp in aseptic condition, 6.7% frozen grilled onion, 4.5% frozen onion, 2.9% double tomato concentrate in aseptic condition, 2.8% sunflower seed oil, 2.2% corn starch, 1.1% mixed flower honey, 1.1% basil, 0.8% salt, 3.2% evaporation water).

The present disclosure is also aimed at the protection of a method for preparing a sheet of dough which includes first of all in receiving, storing and transferring the raw materials required to prepare the sheet of dough.

These raw materials comprise at least two elements chosen preferably from water, legume flour, rice flour, vegetables, vegetable fibers and starches.

The possibility is not excluded that in a particular embodiment the sheet of dough, the optional filling and/or the optional seasoning may also comprise egg or egg parts.

In a subsequent step it is necessary to mix and amalgamate the raw materials until a uniform mixture is obtained.

One then proceeds by passing the mixture through a machine chosen preferably from an extruder, a laminator and the like, in order to obtain a uniform sheet of dough.

At this point one proceeds by optionally performing calibration of the thickness of the sheet of dough.

Once the sheet of dough of the desired thickness has been obtained, one proceeds by cooking and cooling the sheet of dough and by cutting it to predefined shape and dimensions by using a cutting device.

These obtained dough sheet cuttings are then frozen by means of a freezer.

The frozen dough sheet cuttings are then inserted in a container.

Finally, one proceeds with checking, by using a device of the type of a metal detector, X-ray detectors, and the like, for any presence of foreign objects within the containers.

It is specified that prior to this checking step there can be a step of stamping the container in order to indicate the expiry date on the respective label.

Once the checking step has ended, one then proceeds by inserting the container in a secondary and/or tertiary packaging, which is then arranged on a pallet.

Finally, said pallets are stored within cold rooms while waiting for final use.

The present disclosure also relates to a method for preparing pasta which includes first of all in receiving, storing and transferring the raw materials required to prepare the sheet.

These raw materials comprise at least two elements chosen preferably from water, legume flour, rice flour, vegetables, vegetable fibers and starches.

The possibility is not excluded that in a particular embodiment the sheet of dough, the optional filling and/or the optional seasoning may also comprise egg or egg parts.

In a subsequent step it is necessary to mix and amalgamate the raw materials until a uniform mixture is obtained.

One then proceeds by passing the mixture through a machine chosen preferably from an extruder, a laminator and the like, in order to obtain a uniform sheet of dough.

At this point one proceeds by optionally performing the calibration of the thickness of the sheet of dough.

Once the sheet of dough of the desired thickness has been obtained, one then proceeds by performing, in any sequence, at least one step of mechanical treatment, a cooking step, a cooling step and at least one step for cutting the sheet of dough in order to obtain a predefined pasta format.

In the continuation of the description it will be specified that a different sequence of these steps, which follow the step for calibration of the thickness of the sheet of dough, allows to obtain a different and specific pasta format.

The method for providing the pasta then proceeds by performing, in any sequence, at least one step for freezing the pasta and a step for packaging the pasta within a container.

In this case also, the continuation of the description, it will be specified that a different sequence of these steps allows to obtain a different type of packaged pasta.

Once these steps have ended, one then proceeds by inserting the container in a secondary packaging, which is then arranged on a pallet.

Finally, these pellets are stored within cold rooms while waiting for final use.

According to a constructive solution of unquestionable efficiency and effectiveness, after the calibration step it is possible to provide the following steps, which includes cooking and cooling the sheet of dough and cutting it into rectangles by using a cutting device.

These rectangles can then be used to prepare lasagna.

According to a different preferred solution, after the calibration step it is possible to provide the following steps, which includes dosing and placing a filling on the sheet of dough and then folding and closing the sheet of dough according to a predefined format of filled pasta.

At this point one proceeds by cooking the filled pasta, cooling it, with the use of water.

According to a different and additional embodiment solution of unquestionable interest in practice and in application, after the calibration step it is possible to provide the following steps, which includes cooking and cooling the sheet of dough and cutting it into strips by using a cutting device.

At this point one proceeds by dosing and placing a filling on the sheet of dough and by rolling up the sheet of dough on itself so as to form a cylinder, taking care to confine the filling within the sheet of dough.

Finally, one proceeds by again cutting the sheet of dough, filled and closed in a cylindrical than, by using a cutting device, in order to obtain cannelloni.

It is appropriate to specify that the possibility is not excluded to provide different pasta formats, such as for example crespelle or tagliatelle, the method of which is provided by performing, in any sequence, at least one step of mechanical treatment, a cooking step, a cooling step and at least one step for cutting the sheet of dough, in order to obtain a predefined pasta format.

According to the solution that provides for the preparation of a packaged pasta comprising a seasoning, the packaging and freezing steps include dividing the pasta in the containers into portions that correspond to a predefined quantity and adding and amalgamating at least one precooked seasoning in order to season it.

Said pasta, comprising the seasoning, is then frozen by means of a freezer.

One then proceeds by checking, by using a device of the type of a metal detector and the like, for any presence of foreign objects within the containers.

Once the absence of foreign objects has been checked, the containers are closed, checking again, by using a device of the type of an X-ray detector and the like, for any presence of foreign objects inside them.

In this case, the packaged and frozen pasta, comprising the seasoning and inserted in the containers, can be eaten directly by the consumer after cooking in a flying pan or by means of a traditional oven or microwave oven.

Furthermore, it is specified that prior to this second check it is possible to provide a step for stamping the container in order to indicate the best-before date on the respective label, and if there is a band or a case that wraps around the container, a step for its application.

In any case, the possibility is not excluded to perform an additional thermal treatment, prior to the freezing step, in order to obtain the gratin cooking of the upper finishing layer.

According to the solution that provides for the preparation of a packaged pasta without seasoning, the packaging and freezing steps include freezing the pasta by means of a freezer and packaging the pasta in a container.

Finally, one proceeds with checking, by using a device of the type of a metal detector, X-ray detectors and the like, for any presence of foreign objects inside the containers.

It is specified that prior to this checking step it is possible to provide a step for stamping the container in order to indicate the best-before date on the respective label.

In this last case, the frozen pasta inserted in the container can be used by the end consumer as an intermediate product in recipes that he has devised.

It is useful to specify that the method for preparing packaged pasta, according to the disclosure, can comprise a substep for preparing the seasoning which includes receiving, storing and transferring the raw materials and the partially processed ingredients required to prepare the seasoning.

At this point the preparation, mixing and cooking of these raw materials and partially processed ingredients is performed in order to obtain the preset seasoning.

Finally, said seasoning is stored within a tank while waiting to be added to the pasta.

It is specified further that the method for preparing packaged pasta according to the disclosure can comprise a substep for preparing the filling, which include receiving, storing and transferring the raw materials and the partially processed ingredients required to prepare the filling.

At this point the preparation and mixing of these raw materials and partially processed ingredients is performed in order to obtain the preset filling.

The preparation of the raw materials and of the partially processed ingredients can also provide for a step for cooking them.

Finally, said filling is stored within a tank while waiting to be added to the sheet of dough.

Advantageously, the present disclosure offers a commercial response to the new emerging needs, proposing a packaged food product of the type comprising a sheet of dough and a packaged pasta provided with said sheet of dough which are quick and easy to prepare for immediate consumption and with a shelf life of up to 18 months.

Usefully, the packaged food product and the packaged pasta according to the disclosure are gluten-free.

Effectively, the packaged food product of the type comprising a sheet of dough and a packaged pasta, provided with said sheet of dough, contain a high percentage of substances that are rich in proteins.

Usefully, the packaged food product and the packaged pasta, according to the disclosure, do not contain eggs in the mixture.

The possibility is not excluded that in a particular embodiment the sheet of dough, the optional filling and/or the optional seasoning may also comprise egg or egg parts.

Efficiently, the packaged food product of the type comprising a sheet of dough and a packaged pasta, provided by means of said sheet of dough, are suitable to be eaten by people following a vegetarian diet.

Conveniently, the packaged food product of the type comprising a sheet of dough and a packaged pasta, provided by means of said sheet of dough, does not contain additives such as flavor enhancers, preservatives, colors, aromas, and therefore can carry a so-called “clean label” on its packaging.

The “clean label” concept indicates that additives have not been used in the production of the sheet of dough of those food products.

The importance of the “clean label” is further enhanced by the growing market for organic products and by the growing interest of consumers in the source and reliability of the food products that that they purchase.

It is specified that said food product, in particular as regards the Italian territory, can be currently qualified as a food speciality.

The disclosure thus conceived is susceptible of numerous modifications and variations, all of which are within the scope of the appended claims; all the details may furthermore be replaced with other technically equivalent elements.

In the exemplary embodiments shown, individual characteristics, given in relation to specific examples, may actually be interchanged with other different characteristics that exist in other exemplary embodiments.

In practice, the materials used, as well as the dimensions, may be any according to the requirements and the state of the art.

1-15. (canceled)

16. A packaged food product comprising a sheet of dough, wherein said sheet of dough comprises at least two elements chosen from:
water;
legume flour;
rice flour;
vegetables;
vegetable fibers; and
starches;
and wherein said product comprises a container and said product is frozen.

17. A packaged food product, wherein said product is frozen and comprises:
a container; and
a pasta format constituted by a sheet of dough containing at least two elements chosen from water, legume flour, rice flour, vegetables, vegetable flours, and starches.

18. The packaged food product according to claim 17, further comprising a seasoning in order to season said pasta.

19. The packaged food product according to claim 17, wherein said pasta format is chosen from a lasagna, a cannelloni, a pasta with filling, a tagliatella, and a crespella.

20. The packaged food product according to claim 17, wherein said vegetables comprise a pesticide residue lower than a predefined threshold of 0.01 mg/kg.

21. The packaged food product according to claim 17, wherein said vegetables originate from organic farming.

22. The packaged food product according to claim 17, wherein said container is constituted by a body, a pouch, and a combination thereof.

23. The packaged food product according to claim 17, wherein said container is constituted by at least one material selected from ethylene vinyl alcohols (EVOH), polyamide (PA), polyethylene (PE), polyethylene terephthalate (PET), lignin, Cartene, corn-derived polymers, (vegetable) cellulose, paper, cardboard, said container being at least of a type chosen from microwave resistant, partially recyclable, and compostable.

24. A method for preparing a sheet of dough, the method including the following steps:
receiving, storing and transferring raw materials required to prepare said sheet of dough, said raw materials comprising at least two elements chosen from water, legume flour, rice flour, vegetables, vegetable fibers and starches;
mixing and amalgamating said raw materials until a uniform mixture is obtained;
passing the mixture through a machine chosen from an extruder and a laminator, in order to obtain a uniform sheet of dough;
cooking said sheet of dough;
cooling said sheet of dough;
cutting said sheet of dough according to a predefined shape and dimensions by means of a cutting device;
freezing said dough sheet cuttings by means of a freezer;
packaging said dough sheet cuttings in a container; and
checking, by using a device such as a metal detector and X-ray detectors, for any presence of foreign objects inside said containers.

25. A method for preparing pasta, the method including the following steps:
receiving, storing and transferring the raw materials required to prepare said sheet of dough, said raw materials comprising at least two elements chosen from water, legume flour, rice flour, vegetables, vegetable fibers and starches;
mixing and amalgamating said raw materials until a uniform mixture is obtained;
passing the mixture through a machine chosen from an extruder and a laminator, in order to obtain a uniform sheet of dough:
performing, in any sequence, at least one step of mechanical treatment, a cooking step, a cooling step, and at least one step for cutting the sheet of dough, in order to obtain a predefined pasta format; and
performing, in any sequence, at least one step for freezing said pasta and a step for packaging it within a container.

26. The method according to claim 25, wherein after said step for obtaining the sheet of dough the method further includes the following steps:
cooking said sheet of dough;
cooling said sheet of dough; and
cutting said sheet of dough into rectangles by using a cutting device.

27. The method according to claim 25, wherein after said step for obtaining the sheet of dough the method further includes the following steps:
dosing and placing a filling on said sheet of dough;
proceeding with the folding and closing of the sheet of dough according to a predefined format of filled pasta;
cooking said filled pasta; and
cooling said filled pasta by using water.

28. The method according to claim 25, wherein after said step for obtaining the sheet of dough the method further includes the following steps:
cooking said sheet of dough;
cooling said sheet of dough;
cutting said sheet of dough into strips, by means of a cutting device;
dosing and placing a filling on said sheet of dough;
rolling up the sheet of dough on itself so as to form a cylinder, confining the filling within said sheet of dough; and
cutting said sheet of dough closed in the form of a cylinder, by using a cutting device, so as to form substantially cannelloni.

29. The method according to claim 25, wherein said packaging and freezing steps include:
dividing said pasta in said containers into portions that correspond to a predefined quantity;
adding and amalgamating with said pasta at least one precooked seasoning in order to season it;
freezing said pasta by means of a freezer;
checking, by using a metal detector device for any presence of foreign objects inside said containers;
closing said containers; and
checking, by using an X-ray detector device, for any presence of foreign objects inside said containers.

30. The method according to claim 25, wherein said packaging and freezing steps include the following steps:
freezing said pasta by means of a freezer;
packaging said pasta in a container; and
checking, by using a device such as a metal detector and an X-ray detector, for any presence of foreign objects inside said containers.
